(19) United States
(12) Patent Application Publication
(10) Pub. No.: US 2016/0144990 A1
(43) Pub. Date: May 26, 2016

(54) METHOD AND LABELLING MACHINE FOR LABELLING CONTAINERS

(71) Applicant: KHS GMBH, Dortmund (DE)

(72) Inventor: Lutz Körtge, Hamburg (DE)

(73) Assignee: KHS GmbH, Dortmund (DE)

(21) Appl. No.: 14/901,521

(22) PCT Filed: May 15, 2014
(86) PCT No.: PCT/EP2014/001324

§ 371 Date: Dec. 28, 2015

(30) Foreign Application Priority Data
Jun. 27, 2013 (DE) 10 2013 106 757.3
Sep. 5, 2013 (DE) 10 2013 109 691.3

(51) Int. Cl. B65C 9/04; B65C 9/20

(52) U.S. Cl. CPC B65C 9/04; B65C 9/20

(57) ABSTRACT

A method for labeling containers includes applying a first glue-layer on a container, rolling the container about a container axis thereof, while the container is rotating, causing the first glue-layer to contact the first label in the labeling magazine at a leading end of the first label so that the leading end adheres to the container, and, following this contact, causing the first glue-layer to follow a cycloidal path.

### RELATED APPLICATIONS

This is the national stage under 35 USC 371 of international application PCT/EP2014/001324, filed on May 15, 2014, which claims the benefit of the Jun. 27, 2013 priority date of DE 102013106757.3 and the Sep. 5, 2013 priority date of DE 102013109691.3, the contents of both of which are incorporated herein by reference.

### FIELD OF INVENTION

This invention concerns container processing, and in particular, labeling containers.

### BACKGROUND

In a conventional labeling machine, it is difficult to remove labels from a stack of labels in a slip-free manner without exerting considerable tensile forces. These forces can damage very thin labels. In the case of plastic labels, these forces can result in electrostatic charging, which interferes considerably with label handling.

### SUMMARY

A particularity of the invention is that a first layer of glue, during the entire rolling of the particular container on the stack of labels provided in the label magazine, moves over a movement path that corresponds to a right cycloid, and the movement path extends over the entire label length or substantially over the entire label length, wherein the length is that of the labels along a line perpendicular to the axis of the container rolling on the stack of labels, this being possibly diminished by a small partial length of the whole label length that corresponds or substantially corresponds to the overlap area of the wrap-around labels.

A particularity of the method according to the invention includes that of containers rolling slip-free on the stack of labels and thereby the axes of the containers moving along a line whose perpendicular distance from the stack of labels is constant.

In a further development of the invention, the method causes the path corresponding to the right cycloid to extend over the entire label length of the labels provided in the magazine on a level perpendicular to the axis of rotation of the containers when rolled.

Other practices carry out wrap-around labeling by rolling a particular label on the container in such a manner that a trailing label end overlaps the leading label end by an overlap area and is secured or glued by a second layer of glue.

In other practices, the path corresponding to the right cycloid extends from the first label end of the labels provided in the magazine through to the overlap area or substantially through to the overlap area.

In yet other practices, during the entire rolling or placing of the particular label or substantially during the entire rolling or placing of the particular label, the containers or their container axes are moved on a movement path along a line parallel to the label.

In yet other practices, the maximum distance of the path of the first layer of glue corresponding to the right cycloid is the same or substantially the same as the diameter of the containers where they are to be labeled.

Further practices include those in which the first label is arranged along a first line parallel to the label magazine, and that the cycloidal path of the first layer of glue is made mirror-symmetric relative to a second line that, in some cases, is oriented perpendicular to the first line. In some cases, this second line intersects the labels in the center of the label.

In yet other practices, the containers are moved past the label magazine by a transport element or rotor rotating about at least one vertical machine axis and thereby rotated about their container axis oriented parallel or substantially parallel to the machine axis in the opposite direction to the direction of rotation of the transport element and at the same time also moved in a controlled manner radially to the machine axis or direction of rotation of the transport element in such a manner that the first layer of glue is moved on the path corresponding to the right cycloid and/or the containers or their axes are moved on the movement path forming the equidistant line.

In other practices, the rolling of the containers occurs on the stack of labels or along the plane of the label by a slip-free rolling movement, without a slip movement between the container and the stack of labels.

In other practices, a second layer of glue glues the overlap area onto the particular label if the first layer of glue is on a symmetry point or maximum or approximately on the symmetry point or the maximum of its cycloidal path.

Yet other practices include any combination of the foregoing features.

In one aspect, the invention features a method for labeling containers. Such a method includes supplying labels in a labeling magazine, the labels including a first label that is next in line to be placed on a container, moving the container along a movement path, while moving the container along the movement path, applying a first glue-layer on the container, rolling the container about a container axis thereof, causing the first glue-layer to contact the first label at a first contact point, the first contact point being at a leading end of the first label, wherein as a result of the contact, the leading end adheres to the container, and, following the contact, causing the first glue-layer to follow a cycloidal path.

Some practices include causing the first glue-layer to follow a cycloidal path comprises causing the first glue-layer to follow a cycloidal path that extends over a label length, wherein the label extends in a plane that is perpendicular to the container axis.

Other practices include causing the first glue-layer to follow a cycloidal path by rolling the container in such a manner that a trailing end of the label overlaps the leading end of the label along an overlap area, and applying a second glue-layer to secure the trailing end at the overlap area. Among these practices are those that include rolling the container in such a manner that the cycloidal path extends from the leading end to the overlap area, those that include rolling the container in such a manner that the cycloidal path extends from the first label end through the overlap area, and those that include the second glue-layer when the first glue-layer has reached a point of mirror symmetry on the cycloidal path.

In some practices, causing the first glue-layer to follow a cycloidal path includes causing the container axis to follow a path having a path section that is parallel to a line defined by the first label and offset from the line. Among these are practices in which the offset is equal to a diameter of the container at a location at which the container is to be labeled.

In yet other practices, the first label is parallel to a first line, a second line that intersects the first line defines a point at which the cycloidal path is furthest from the first line, and the cycloidal path followed by the first glue-layer is mirror symmetric about this point. Among these are practices in which the first label extends along a longitudinal axis, the first label has a length along the longitudinal axis, the length being a distance from a leading edge of the first label to a trailing edge of the first label, a center of the first label is located at a distance from the leading edge of the first label that is half of the length, and the second line intersects the label at the center. Also among these practices are those in which the first label extends along a longitudinal axis, the first label defines a first length along the longitudinal axis, the first length being a distance from a leading edge of the first label to a trailing edge of the first label, the first label defines a second length, the second length is a length of an overlap area, a third length is equal to the first length minus the second length, a fourth length is equal to half of the third length, and wherein a between a point at which second line intersects the first label and the leading edge of the first label is equal to the fourth distance.

In other practices, moving the container along a movement path comprises moving the container past the label magazine along a path parallel to a line parallel to a plane defined by the first label using a rotor that is rotating about a machine axis in a first direction to move the container, simultaneously rotating the container about a container axis thereof in a second direction opposite the first direction, and simultaneously moving the container radially relative to the machine axis in such a manner that the first glue-layer moves along the cycloidal path and the container axis follows the line.

Also among the practices of the invention are those in which rolling the container includes rolling in a manner that avoids slip between the container and the first label.

In some practices, the labels are shield labels. These practices include applying a second glue-layer for gluing a trailing end of the first shield label on the container where the trailing end is to be attached.

In another aspect, the invention features an apparatus for labeling containers according to a roll-fit labeling method. Such an apparatus includes a rotor, processing positions, a container inlet, a first glue-applicator, a label magazine, and a radial drive. The rotor is configured to rotate relative to a stationary reference frame about a machine axis along a first direction. The processing positions are disposed along a periphery of the rotor. The container inlet is configured for admitting containers into processing positions. The first glue-applicator is a stationary glue-applicator downstream of the container inlet in the rotation direction and configured for applying a first glue-layer to a container. The label magazine follows the first glue-applicator in the rotation direction and holds labels arranged in a label stack. Each processing position comprises a container clamp, a container carrier, and a rotary drive for rotating the container carrier about a container axis of the processing position. The rotary drive can be controlled in such a way that a container having a first glue-layer thereon, when moved past the label magazine by the rotor and held between the container clamping element and the container carrier grasps a first label on a front of the stack of labels by being rolled on the label while the first drive rotates the container holder. The radial drive controls radial movement of each processing position in a direction radial to the first direction so that a movement path of the processing positions of the containers when moving past the label magazine runs along a line that is parallel to and offset from a line defined by a labels in the label magazine.

In some embodiments, the radial drive and the rotary drive control movement of a processing position in such a way that the first glue-layer traverses a cycloidal path.

As used herein, the term “containers” refers to cans and bottles, in each case made of metal, glass, and/or plastic, insofar as they have a container shape that is suitable for the hot-melt labeling.

As used herein, expressions such as “substantially,” or “approximately” refer to deviations from an exact value of ±10%, preferably of ±5%, and/or deviations in the form of changes not significant for function.

Further developments, benefits, and application possibilities of the invention arise from the following description of examples of embodiments and from the figures. Moreover, all characteristics described and/or illustrated individually or in any combination are categorically the subject of the invention, regardless of their inclusion in the claims or reference to them. The content of the claims is also an integral part of the description.

### BRIEF DESCRIPTION OF THE DRAWINGS

These and other features and advantages of the invention will be apparent from the following detailed description and the accompanying figures, in which:

FIG. 1 shows a side view of a container labeled with a wrap-around label;

FIG. 2 shows a plan view of a labeling machine for placing labels as shown in FIG. 1;

FIG. 3 shows a side view of a processing position from the labeling machine of FIG. 2; and

FIG. 4 shows the labeling machine of FIG. 2 but reconfigured to apply shield labels.

### DETAILED DESCRIPTION

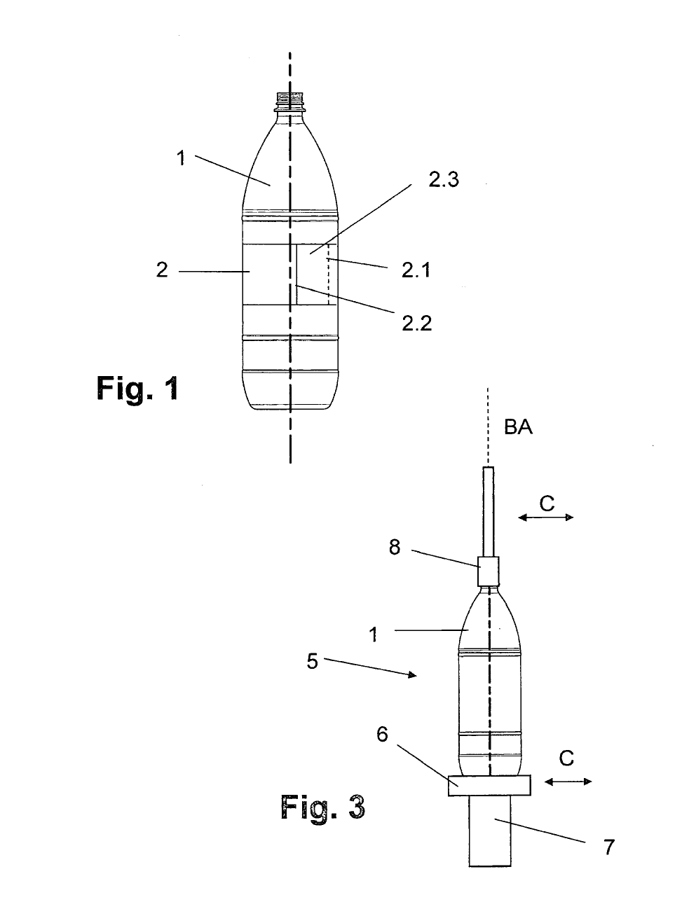

FIG. 1 illustrates a wrap-around label 2 that encompassing an outer surface of a container 1. In the illustrated embodiment, the container 1 is a bottle. However, any container can be used.

During the labeling process, a first glue application secures the label's leading end 2.1 to the container 1. Also during the labeling process, a second glue application secures the label's trailing end 2.2 so that it overlaps an area of the label 2. This area is referred to herein as an “overlap area 2.3.”

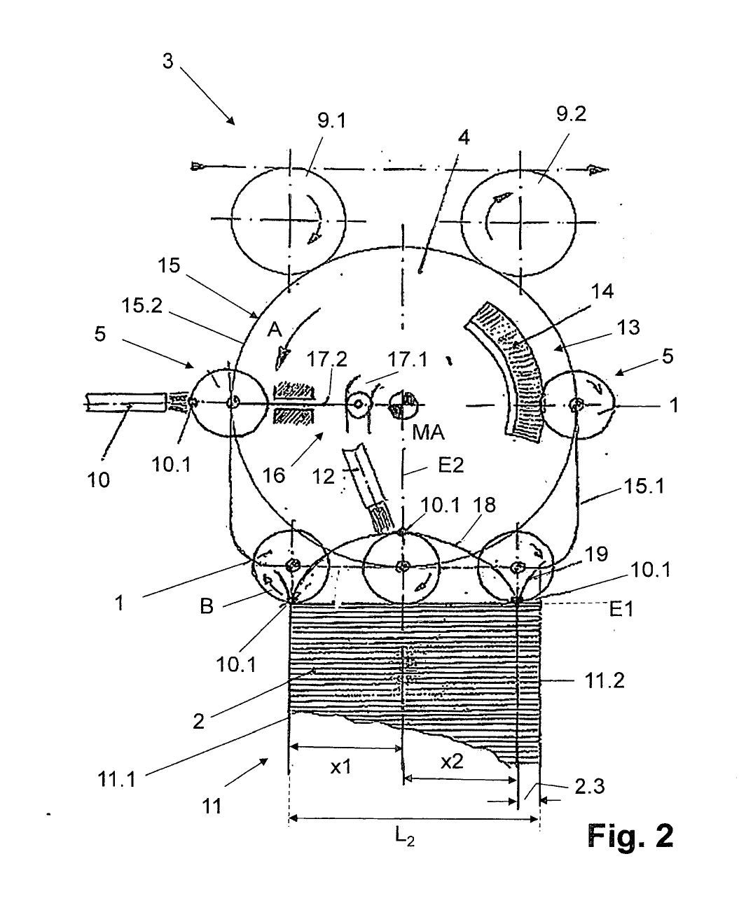

FIG. 2 shows a labeling machine 3 suitable for labeling containers 1. The labeling machine 3 includes a first drive that rotates a rotor 4 about a vertical machine axis MA along a first direction A. Along the rotor's circumference are processing positions 5 separated from each other by regular angular distances. Each processing position 5 receives a container 1 arranged with its container axis parallel or substantially parallel to the machine axis MA.

As shown in FIG. 3, each processing position 5 has a rotary plate 6 on which a container 1 stands upright on its base. Each processing position 5 also has a stamp 8 that lies above and against the container's sealed opening.

A second drive 7 rotates the rotary plate 6 along a second direction B about a container axis BA that is parallel to the machine axis MA. The second direction B is opposite the first direction A. Thus, if the first direction A is clockwise, the second direction B will be counter-clockwise and vice versa. A suitable second drive 7 is a controllable electric servo-drive.

A third drive 16, best seen in FIG. 2, moves the rotary plate 6 and the associated stamp 8 of each processing position 5 in a controlled manner along a third direction C that is radial to the machine axis MA.

An alternative labeling machine 3 handles containers by their necks only. In these embodiments, instead of the rotary plate 6 and the stamp 8, each processing position 5 has a holding-and-rotating device that grips the container 1 only in the area of its sealed container opening and/or by a container flange or neck ring located there. During labeling, the second drive 7 rotates the rotary plate 6 in a controlled manner about the container axis BA. This alternative embodiment is useful for light containers, such as plastic or PET containers. However, the basic principles of the method disclosed herein are applicable to such labeling machines.

Referring to FIG. 3, a first transport-star 9.1 brings a container 1 to a container inlet of the rotor 4 where it is placed on a processing position 5. As the rotor 3 rotates in the first direction A, the processing position 5 brings the container 1 to a first glue-applicator 10, which applies a first glue-layer 10.1 to an area of the container that faces away from the machine axis MA. The first glue-applicator 10 is located radially outside the movement path of the processing positions 5. This first glue-applicator 10 is thus stationary. It does not rotate with the rotor 4. In some embodiments, the first glue-applicator 10 includes a glue roller for applying the first glue-layer 10.1.

Further rotation in the first direction A brings the container 1 to a stationary label-magazine 11 having a label stack. The label magazine 11 includes an upstream side 11.1 and a downstream side 11.2. Like the first glue applicator 10, the label magazine 11 lies radially outside the movement path of the processing positions 5 and does not rotate with the rotor 3.

While the container 1 is in the area of the label magazine 11, it encounters a second glue-applicator 12. Unlike the first glue-applicator 10, the second glue-applicator 12 lies radially inside of the movement path of the processing positions 5. This second glue-applicator 12 applies a second glue-layer.

As it rotates further in the first direction A, the rotor 3 takes the container past the label magazine 11 to a brushing section 13 having a brush 14 likewise not moved with the rotor 4. Further rotation of the rotor 3 brings the container, now labeled, to a container outlet. At the container outlet, the container 1 is moved from the processing station 5 to a second transport-star 9.2, which supplies it to an external conveyor.

In some embodiments, the first and second glue-applicators 10, 12 are configured for application of hot glue, or hot-melt adhesive. Each of the first and second glue applicators 10, 12 includes one or more nozzles for applying hot glue. In those embodiments having plural nozzles, the nozzles are offset from each other in a vertical direction.

In FIG. 3, the topmost label 2 in the label stack extends along a horizontal line E1 across the label magazine 11. This topmost label 2 is the label is first in line to be applied to a container 1.

A vertical line E2 extending radially outward from the machine axis MA intersects the horizontal line E1 at a point that is a first distance x1 from the upstream side 11.1 and a second distance x2 from the downstream side 11.2. In the configuration shown, the sum of the first distance x1, the second distance x2, and the length of the overlap 2.3 is the greatest width L₂ of the interior of the label magazine 11 and the length of the longest label that can be processed by the labeling machine 3.

In operation, the labeling machine 3 labels a container by first having the first transport-star 9.1 transfer it to a processing position 5. Once there, it lowers the stamp 8 and clamps the container 1 between the stamp 8 and the rotary plate 6.

With the container 1 now clamped, the labeling machine 3 brings the container 1 to the first glue-applicator 10. The first glue-applicator 10 then applies the first glue-layer 10.1 on the container area to be labeled.

When the container reaches the upstream side 11.1 of the label magazine 11, this first glue-layer 10.1 on the container 1 contacts the leading end 2.1 of the uppermost label 2 provided in the label magazine 11, namely the label 2 that extends along the horizontal line E1. This point will be referred to as the “first contact point” to distinguish it from a “second contact point” discussed below in connection with the operation of the third drive 16.

The rotor 4 continues to move the container 1 along the first direction A. As it does so, the rotary plate 6 rotates the container 1 in the second direction B about its container axis BA. The combination of the two opposing first and second directions A, B removes the label 2 from the label magazine 11 and rolls it onto the container 1.

Once the processing position 5 with the container 1 has reached approximately the center of the label magazine 11, the second glue applicator 12 applies a second layer of glue to the leading end 2.1 of the label 2.

As the rotor 4 and the rotary plate 6 continue their respective rotations, the label is completely removed from the label magazine 11 and rolled onto the container 1. Eventually, the label's trailing end 2.2 overlaps its leading end 2.1 at the overlap area 2.3, with the latter being glued by the second layer of glue.

The labeling machine 3 then brings the container to the brushing section 13. Meanwhile, the rotary plate 6 continues to rotate. At the brushing section 13, the brush 14 presses and brushes the overlap area 2.3.

To more gently remove the labels 2 from the label magazine 11 and to more gently and carefully roll these labels 2 onto the containers 1, the processing position 5 follows an overall movement path 15 having a first path section 15.1 and second path section 15.2.

The second path section 15.2 follows the rotor 4 between the brushing section 13 and the first glue-applicator 10. The second path section 15.2 thus follows an arcuate path whose length is half the circumference of the rotor 4.

The first path section 15.1 begins at a first point of tangency with the rotor 4 at the first glue applicator 10, where it joins the second path section 15.2. Rather than follow the rotor 4, the first path section 15.1 launches itself in a straight line away from the rotor 4 at the first glue applicator 10 towards the horizontal line E1.

Before reaching the first horizontal line E1, the first path section 15.1 makes a turn towards the vertical line E2. It then continues in a straight line across the labeling magazine 11 and offset from the horizontal line E1 by a distance equal to half the diameter of a container 1 at the section on which it is to be labeled.

After having traversed the labeling magazine 11, the first path section 15.1 makes a turn towards the brushing section 13. It then proceeds in a straight line until it joins the second path section 15.2 at a second point of tangency with the rotor 4.

Because the processing position 5 is on a rotating rotor 4, it naturally follows the second section 15.2. However, to make the processing position 5 follow the first path section 15.1 requires the third drive 16 to intervene. In particular, the third drive 16 must move the rotary plate 6 and stamp 8 along the third direction C. This third direction C is a radial direction relative to the machine axis MA.

In some embodiments, the third drive 16 is an actuating drive. In others, it is a control drive. The third drive 16 can be made in a variety of ways. One particular drive includes a control cam 17.1 and a roller lever 17.2. The control cam 17.1 permits the third drive 16 to control movement of the rotary plate 6 and the stamp 8 based on the rotary position of the rotor 4 so that the center of the rotary plate 6 can follow the first path section 15.1.

As the processing position 5 traverses the first path section 15.1, and in particular, as it traverses the labeling magazine 11, the rotary plate 6 continues to rotate in such a way that, when the processing position 5 reaches the vertical line E2, the first glue-layer 10.1 on the container 1 faces away from the label magazine 11. As the processing position 5 moves further along the first path section 15.1, the rotary plate 6 continues to rotate, thus bringing the first glue-layer 10.1 back toward the horizontal line E1.

Eventually, the first glue-layer 10.1 reaches the horizontal line E1 once again at a second contact point. This second contact point is closer to the downstream side 11.2 of the label magazine 11 than the first contact point. In particular, the distance between the second contact point and the downstream side 11.2 of the label magazine 11 corresponds to the length of the overlap area 2.3.

As a result of the foregoing movements, the first glue-layer 10.1 traverses a first cycloid 18 and part of a second cycloid 19. The segment along the label magazine 11 between the first and second contact points is the length of the first cycloid 18. The amplitude of the first cycloid 18 corresponds to the maximum distance of the first glue-layer 10.1 from the horizontal line E1, which is the same or substantially the same as the diameter of the containers 1 at their area to be labeled. After the second contact point, the first glue-layer 10.1 moves along the second cycloid 19.

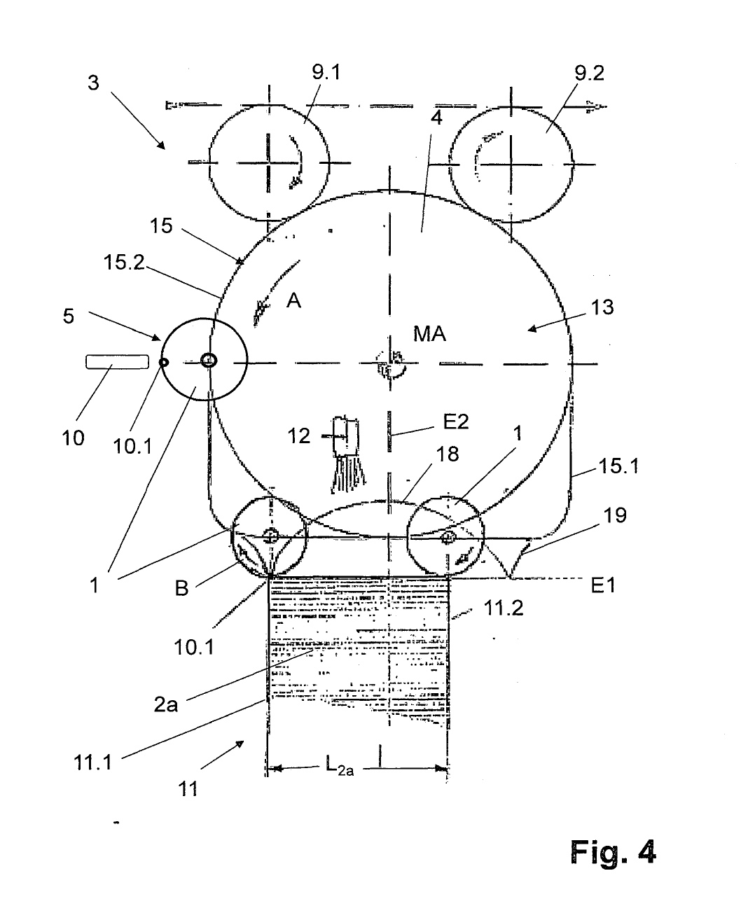

FIG. 4 shows the labeling machine 3 configured to apply shield labels 2a. When applied to a container 1, a shield label 2a extends across only part of the container's circumference.

A shield label 2a has a leading end 2.1 and a trailing end 2.2 separated by a shorter distance L₂ₐ. This distance L₂ₐ separates the upstream side 11.1 and the downstream side 11.2 of the label magazine 11.

The operation of the labeling machine 3 is similar to that described above with the exception that the length of the first cycloid 18 is now greater than the extent of the label magazine 11. As a result, there is no second contact point. By the time the first glue-layer 10.1 returns to the horizontal line E1, it is already beyond the downstream side 11.2 of the label magazine 11.

When the labeling machine 3 is configured to apply shield labels 2a, the second glue-applicator 12 is arranged such that the second layer of glue is applied on the particular container 1 in an area that corresponds to the trailing end 2.2 of the shield label 2a.

The control of the second drive 7 and the third drive 16 is such as to maintain correct slip-free rolling of the container 1 on the stack of labels in the label magazine 11 over the entire length L₂, L₂ₐ of the labels 2, 2a so that very thin labels and/or plastic labels can also be processed, without damaging the labels 2, 2a and without electrostatic charging of the labels as they are removed from the label magazine 11. As a result, in the case of plastic labels, no additional antistatic coating or similar precautions are needed to prevent the electrostatic charging. The method according to the invention thus promotes a drastic reduction in the costs for the label material. This reduction is such that the cost of plastic labels can be brought down to almost the cost of paper labels.

Having described the invention, and a preferred embodiment thereof, what is claimed as new, and secured by Letters Patent is:

1-14. (canceled)

15. A method for labeling containers, said method comprising supplying labels in a labeling magazine, said labels including a first label that is next in line to be placed on a container, moving said container along a movement path, while moving said container along said movement path, applying a first glue-layer on said container, rolling said container about a container axis thereof, causing said first glue-layer to contact said first label at a first contact point, said first contact point being at a leading end of said first label, wherein as a result of said contact, said leading end adheres to said container, and, following said contact, causing said first glue-layer to follow a cycloidal path.

16. The method of claim 15, wherein said label has a label length, wherein causing said first glue-layer to follow a cycloidal path comprises causing said first glue-layer to follow a cycloidal path that extends over said label length, wherein said label extends in a plane that is perpendicular to said container axis.

17. The method of claim 15, wherein causing said first glue-layer to follow a cycloidal path comprises rolling said container in such a manner that a trailing end of said label overlaps said leading end of said label along an overlap area, said method further comprising applying a second glue-layer to secure said trailing end at said overlap area.

18. The method of claim 17, wherein causing said first glue-layer to follow a cycloidal path comprises rolling said container in such a manner that said cycloidal path extends from said leading end to said overlap area.

19. The method of claim 17, wherein rolling said container in such a manner that said cycloidal path extends from said first label end through said overlap area.

20. The method of claim 17, wherein applying a second glue-layer comprises applying said second glue-layer when said first glue-layer has reached a point of mirror symmetry on said cycloidal path.

21. The method of claim 15, wherein causing said first glue-layer to follow a cycloidal path comprises causing said container axis to follow a path having a path section that is parallel to a line defined by said first label and offset from said line.

22. The method of claim 21, wherein said offset is equal to a diameter of said container at a location at which said container is to be labeled.

23. The method of claim 15, wherein said first label is parallel to a first line, wherein a second line that intersects said first line defines a point at which said cycloidal path is furthest from said first line, and wherein said cycloidal path followed by said first glue-layer is mirror symmetric about said second line.

24. The method of claim 23, wherein said first label extends along a longitudinal axis, wherein said first label has a length along said longitudinal axis, said length being a distance from a leading edge of said first label to a trailing edge of said first label, wherein a center of said first label is located at a distance from said leading edge of said first label that is half of said length, wherein said second line intersects said label at said center.

25. The method of claim 23, wherein said first label extends along a longitudinal axis, wherein said first label defines a first length along said longitudinal axis, said first length being a distance from a leading edge of said first label to a trailing edge of said first label, wherein said first label defines a second length, wherein said second length is a length of an overlap area, wherein a third length is equal to said first length minus said second length, wherein a fourth length is equal to half of said third length, and wherein a distance between a point at which second line intersects said first label and said leading edge of said first label is equal to said fourth distance.

26. The method of claim 15, wherein moving said container along a movement path comprises moving said container past said label magazine along a path parallel to a line parallel to a plane defined by said first label using a rotor that is rotating about a machine axis in a first direction to move said container, simultaneously rotating said container about a container axis thereof in a second direction opposite said first direction, and simultaneously moving said container radially relative to said machine axis in such a manner that said first glue-layer moves along said cycloidal path and said container axis follows said line.

27. The method of claim 15, wherein rolling said container comprises rolling in a manner that avoids slip between said container and said first label.

28. The method of claim 15, wherein supplying labels comprises supplying shield labels, wherein said first label that is next in line to be placed on a container is a first shield label, said method further comprising applying a second glue-layer for gluing a trailing end of said first shield label, wherein applying said second glue-layer comprises applying said second glue-layer on said container where said trailing end is to be attached.

29. An apparatus for labeling containers according to a roll-fit labeling method, said apparatus comprising a rotor, processing positions, a container inlet, a first glue-applicator, a label magazine, and a radial drive, wherein said rotor is configured to rotate relative to a stationary reference frame about a machine axis along a first direction, wherein said processing positions are disposed along a periphery of said rotor, wherein said container inlet is configured for admitting containers into processing positions, wherein said first glue-applicator is downstream of said container inlet in said rotation direction, wherein said first glue-applicator is configured for applying a first glue-layer to a container, wherein said first glue-applicator is in said stationary reference frame, wherein said label magazine follows said first glue-applicator in said rotation direction, wherein said label magazine is configured to hold labels arranged in a label stack, wherein each processing position comprises a container clamp, a container carrier, and a rotary drive for rotating said container carrier about a container axis of said processing position, wherein said rotary drive can be controlled in such a way that a container having a first glue-layer thereon, when moved past said label magazine by said rotor and held between said container clamping element and said container carrier grasps a first label on a front of said stack of labels by being rolled on said label while said first drive rotates said container holder, wherein said radial drive is configured to cause controlled radial movement of each processing position in a direction radial to said first direction in such a manner that a movement path of said processing positions of said containers when moving past said label magazine runs along a line that is parallel to and offset from a line defined by a labels in said label magazine.

30. The apparatus of claim 29, wherein said radial drive and said rotary drive control movement of a processing position in such a way that said first glue-layer traverses a cycloidal path.
